(19) United States
(12) Patent Application Publication
(10) Pub. No.: US 2013/0293006 A1
(43) Pub. Date: Nov. 7, 2013

(54) BATTERY BALANCING SYSTEM AND BATTERY BALANCING METHOD USING THE SAME

(71) Applicant: LG CHEM, LTD., Seoul (KR)

(72) Inventors: Jung-Soo KANG, Daejeon (KR); Dae-Sik CHUNG, Gwangmyeong-si (KR)

(73) Assignee: LG CHEM, LTD., Seoul (KR)

(21) Appl. No.: 13/874,554

(22) Filed: May 1, 2013

(30) Foreign Application Priority Data
May 2, 2012 (KR) 10-2012-0046260

(51) Int. Cl. H02J 1/10

(52) U.S. Cl. CPC H02J 1/10
USPC 307/10.1; 307/80; 307/9.1

(57) ABSTRACT

A battery balancing system for equalizing charge amounts of a plurality of batteries includes a state measuring unit for measuring states of the plurality of batteries, a controller for outputting a switching control signal including a balancing initiation signal and a balancing termination signal with reference to the state information measured by the state measuring unit, and a switch unit for simultaneously connecting the plurality of batteries to a balancing circuit unit in parallel according to the balancing initiation signal and simultaneously releasing the parallel connection according to the balancing termination signal. Therefore, when balancing charge amounts of a plurality of batteries, it is possible to balance all batteries together by using a simple circuit configuration.

### CROSS-REFERENCE TO RELATED APPLICATION

The present application claims priority to Korean Patent Application No. 10-2012-0046260 filed in the Republic of Korea on May 2, 2012, the disclosures of which are incorporated herein by reference.

### BACKGROUND OF THE DISCLOSURE

1. Field of the Disclosure

The present disclosure relates to a battery balancing system and a battery balancing method using the same, and more particularly, to a battery balancing system and a battery balancing method using the same, which may equalize charge amounts of batteries within a short time by using a simple circuit configuration.

2. Description of the Related Art

Generally, secondary batteries are classified into nickel cadmium batteries, nickel hydrogen batteries, lithium ion batteries, lithium ion polymer batteries or the like. These secondary batteries are applied to and used for not only small products such as digital cameras, P-DVD, MP3P, cellular phones, PDA, portable game devices, power tools and E-bikes but also large products demanding high power such as electric vehicles and hybrid vehicles and storage devices such as energy storage devices and back-up energy storage devices which store surplus generated power or new generation energy.

Meanwhile, a large-capacity battery used for an electric vehicle, a hybrid electric vehicle or an energy storage device includes a plurality of unit cell assemblies connected in series and/or in parallel. In a battery having a plurality of unit cells connected to each other, charge capacities of the unit cells deviate from each other as charging/discharging processes are repeated. If charging and discharging are repeated while such charge capacity deviation is neglected, some unit cells may be overcharged or overdischarged. The overcharging or overdischarging state may be a factor of safety deterioration of the unit cells and on occasion may cause an unexpected accident such as explosion.

In order to solve the above problems, various kinds of circuits have been proposed for continuously monitoring charge amounts of battery cells and balancing the charge amounts of the battery cells to a certain level. Such circuits are applied to and used for a battery management system.

In order to balance charge amounts of battery cells, a cell with high voltage may be discharged to lower its voltage level, or a cell with low voltage may be further charged to raise its voltage level. Either way, in the conventional art, voltages of a plurality of cells are individually adjusted for balancing. However, if the above method is used, a complicated control circuit is required to balance a plurality of cells, and the time required for balancing is inevitably elongated. Accordingly, in the technical field of the present disclosure, there is needed a scheme capable of balancing charge amounts of battery cells rapidly by using a simple circuit configuration.

### SUMMARY OF THE DISCLOSURE

The present disclosure is designed to solve the problems of the prior art, and therefore it is an object of the present disclosure to provide a battery balancing system and a battery balancing method using the same, which may balance charge amounts of batteries rapidly by using a simple circuit configuration.

In order to accomplish the above object, the present disclosure provides a battery balancing system for equalizing charge amounts of a plurality of batteries, which includes a state measuring unit for measuring states of the plurality of batteries; a controller for outputting a switching control signal including a balancing initiation signal and a balancing termination signal with reference to the state information measured by the state measuring unit; and a switch unit for simultaneously connecting the plurality of batteries to a balancing circuit unit in parallel according to the balancing initiation signal and simultaneously releasing the parallel connection according to the balancing termination signal.

In one aspect, the state measuring unit may include at least one of a voltage measurer, a current measurer and a temperature measurer.

In another aspect, the controller may calculate states of charge (SOCs) of the batteries by using the state information, compare a deviation of the SOCs with a reference value, and when a balancing initiation condition is satisfied, output the balancing initiation signal.

In another aspect, the controller may calculate a difference between a maximum value and a minimum value of the measured voltages of the plurality of batteries, compare the difference with a reference value, and when a balancing initiation condition is satisfied, output the balancing initiation signal.

In another aspect, the controller may output the balancing termination signal after passage of time which is proportional to a difference between a maximum value and a minimum value of voltages measured at both terminals of the plurality of batteries at the point when the balancing initiation signal is output.

In another aspect, the controller may compare current values between the batteries and the balancing circuit unit in the state information with a reference value, and when a balancing termination condition is satisfied, output the balancing termination signal.

In another aspect, the controller may compare a deviation of the SOCs or voltages of the batteries respectively calculated or measured during a balancing mode with a reference value, and when a balancing termination condition is satisfied, output the balancing termination signal.

In the present disclosure, the balancing circuit unit may include a resistor connected between both terminals of each battery when the controller outputs the balancing initiation signal.

In the present disclosure, the balancing circuit unit may include at least one resistor connected between adjacent batteries among the plurality of batteries when the controller outputs the balancing initiation signal.

In the present disclosure, the switch unit may connect the plurality of batteries to an external circuit unit when the parallel connection is released. Here, the external circuit unit may include an external device connected at both terminals of each battery, and the external device may include at least one of charger equipment and a device operating with power supplied from the batteries.

According to an aspect of the present disclosure, the battery may be any one selected from the group consisting of a unit cell, a battery module, a battery pack where a plurality of battery modules are connected, and a battery rack where the battery modules are loaded in multi layers.

According to another aspect of the present disclosure, the battery may be the battery pack or the battery rack, and the balancing circuit unit may have bus lines respectively connected to the battery modules.

According to another aspect of the present disclosure, the battery rack may include a plurality of the battery modules loaded therein, and the plurality of batteries may be connected in parallel by the bus lines.

The object of the present disclosure may also be accomplished by an electronic device, an electric vehicle, a hybrid vehicle or a power storage device, to which the battery balancing system is applied.

Meanwhile, in order to accomplish the above object, the present disclosure also provides a battery balancing method for balancing charge amounts of a plurality of batteries by using a switch unit which connects the batteries to a balancing circuit unit in parallel or releasing the parallel connection, which includes: collecting state information of the plurality of batteries; outputting a balancing initiation signal, which causes the parallel connection, to the switch unit when a balancing initiation condition is satisfied with reference to the collected state information; and outputting a balancing termination signal, which causes the parallel connection to be released, to the switch unit when a balancing termination condition is satisfied with reference to the collected state information.

According to the present disclosure, when balancing charge amounts of a plurality of batteries, all batteries may be balanced together by using a simple circuit configuration.

### BRIEF DESCRIPTION OF THE DRAWINGS

The accompanying drawings illustrate preferred embodiments of the present disclosure and, together with the foregoing disclosure, serve to provide further understanding of the technical spirit of the present disclosure. However, the present disclosure is not to be construed as being limited to the drawings in which:

FIG. 1 is a block diagram showing a battery balancing system according to a preferred embodiment of the present disclosure;

FIG. 2a is a diagram showing that batteries of the battery balancing system of FIG. 1 are connected to an external circuit unit;

FIG. 2b is a diagram showing that batteries of the battery balancing system of FIG. 1 are connected to a balancing circuit unit;

FIG. 2c is a diagram showing that an additional resistor is connected to the circuit of FIG. 2b;

FIG. 3 is a diagram showing that batteries of the battery balancing system of FIG. 1 are connected by bus lines; and

FIG. 4 is a flowchart for illustrating a battery balancing method according to a preferred embodiment of the present disclosure.

Reference Symbols

| | |
|---|---|
| 1: battery unit | 2: state measuring unit |
| 3: controller | 4: switch unit |
| 5: balancing circuit unit | 6: external circuit unit |
| B: battery | S: switching element |
| R, r: resistor | D: external device |
| L: bus line | 1: first bus line |
| L2: second bus line | |

### DESCRIPTION OF THE PREFERRED EMBODIMENT

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

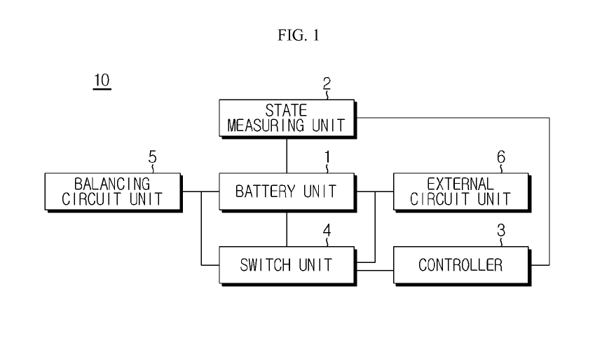

A battery balancing system 10 according to a preferred embodiment of the present disclosure will be described with reference to FIGS. 1 to 3.

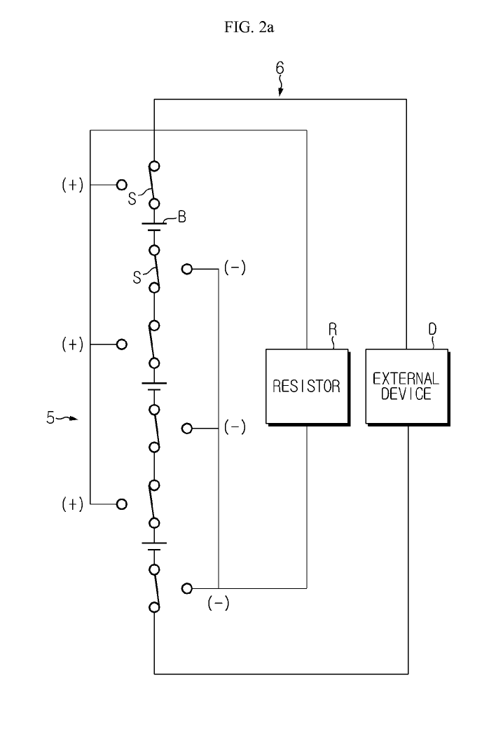

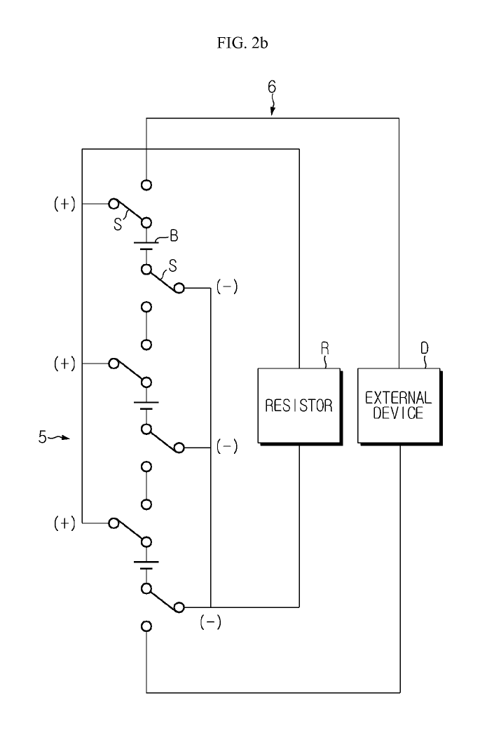

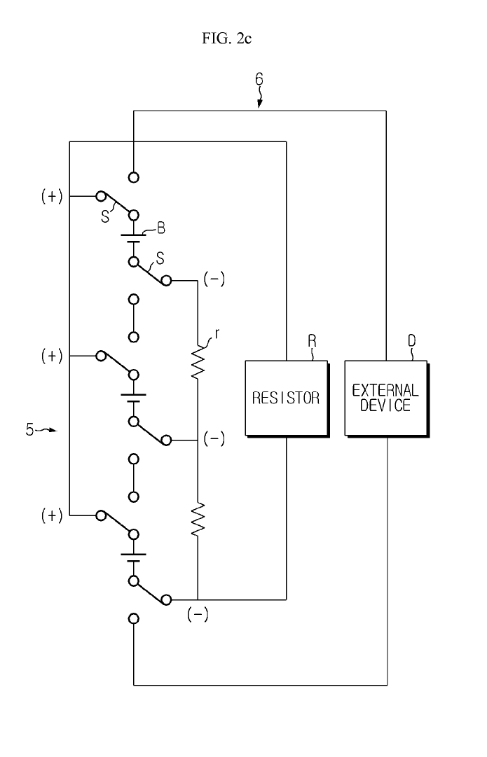

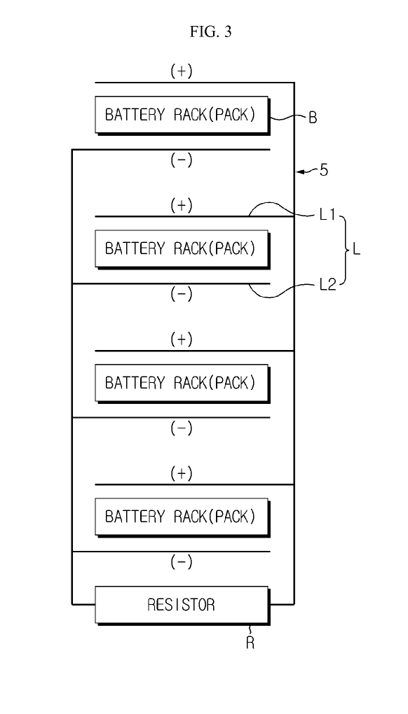

FIG. 1 is a block diagram showing a battery balancing system according to a preferred embodiment of the present disclosure, FIG. 2a is a diagram showing that batteries of the battery balancing system of FIG. 1 are connected to an external circuit unit, FIG. 2b is a diagram showing that batteries of the battery balancing system of FIG. 1 are connected to a balancing circuit unit, FIG. 2c is a diagram showing that an additional resistor is connected to the circuit of FIG. 2b, and FIG. 3 is a diagram showing that batteries of the battery balancing system of FIG. 1 are connected by bus lines.

Referring to FIGS. 1 to 3, the battery balancing system 10 according to a preferred embodiment of the present disclosure includes a battery unit 1, a state measuring unit 2, a controller 3, a switch unit 4, a balancing circuit unit 5 and an external circuit unit 6.

The battery unit 1 includes a plurality of batteries B connected in series and/or in parallel (see FIGS. 2a and 2b). The battery B represents a unit which may be repeatedly charged and discharged by means of electrochemical reaction. For example, the battery B means a unit cell, a battery module including a plurality of unit cells connected in series and/or in parallel, a battery pack where a plurality of battery modules are connected in series and/or in parallel, or a battery rack where battery modules are loaded in multi layers.

The state measuring unit 2 includes a voltage measurer and/or a current measurer (not shown) connected to the battery unit 1 and provides state information, obtained by measuring an electric state of the battery unit 1, to the controller 3.

The voltage measurer is connected to both terminals of each battery B and/or both terminals of the battery unit 1 in order to measure voltages at both terminals of each battery B and/or voltages at both terminals of the battery unit 1. The current measurer is connected between both terminals of the battery unit 1 in order to measure a discharge current flowing on the circuit when both terminals of the battery unit 1 are connected to the balancing circuit unit 5.

The state information includes information about voltage values of the battery unit 1 and/or the battery B, measured by the voltage measurer, and discharge current values flowing between the battery unit 1 and the balancing circuit unit 5, measured by the current measurer.

The controller 3 outputs a switching control signal including a balancing initiation signal and a balancing termination signal with reference to the state information measured by the state measuring unit 2.

The controller 3 compares the state information such as a voltage value or a current value with a preset reference value or compares a deviation of states of charges (SOCs) of the batteries B, calculated by using the state information with a reference value, and then, if a balancing initiation condition is satisfied, outputs a balancing initiation signal. Here, SOC of each battery B may be calculated by using various methods known in the art, for example by counting current, by referring to a look-up table, by estimating based on mathematical modeling, by using a Kalman filter or the like. In addition, while calculating SOC of each battery B, if temperature information of each battery B is required, the state measuring unit 2 may selectively further include a temperature measurer which periodically measures temperature of each battery B and provides the measured temperature information to the controller 3, as obvious to those skilled in the art. Meanwhile, the condition for outputting the balancing initiation signal is not limited to the above. In other words, the controller 3 may be set to output a balancing initiation signal according to various criteria, for example when a difference between a maximum value and a minimum value of measured voltages of the batteries B is equal to or greater than a certain reference value, in addition to the above, as obvious to those skilled in the art.

The controller 3 determines a time taken from the point when the balancing initiation signal is output to the point when the balancing termination signal is output, namely a balancing mode maintaining time t of the battery balancing system 10, based on the state information measured by the state measuring unit 2.

The controller 3 may be set to maintain a balancing mode during, for example, the time t proportional to a difference between a maximum value and a minimum value of voltages at both terminals of the batteries B, measured at the point when the balancing initiation signal is output. However, the criterion for determining the time during which the controller 3 maintains the balancing mode, namely the criterion for outputting the balancing termination signal, is not limited thereto. In other words, the controller 3 may be set to output a balancing termination signal according to various criteria, for example at a point when a discharge current flowing between the battery unit 1 and the balancing circuit unit 5 decreases smaller than a preset reference current value in the balancing mode, at a point when a deviation of SOCs or voltages of the batteries B respectively calculated or measured during the balancing mode decreases lower than a certain level, or the like.

The switch unit 4 includes a plurality of switching elements S and performs a switching operation according to a control signal output from the controller 3. The switching element S (see FIGS. 2a and 2b) may employ an element commonly used in the art, such as a field effect transistor (FET). However, the present disclosure is not limited thereto, and an element capable of selectively connecting the battery unit 1 to the balancing circuit unit 5 or the external circuit unit 6 according to a control signal output from the controller 3 may be used as the switching element S of the present disclosure without restriction, as obvious to those skilled in the art.

In the case the control signal output from the controller 3 is a balancing initiation signal, the switch unit 4 connects both terminals of the battery unit 1 to the balancing circuit unit 5 so that a discharge current flows, and also allows the plurality of batteries B included in the battery unit 1 to be connected to each other in parallel. In other words, the switch unit 4 simultaneously connects the batteries S, which will be balanced according to the balancing initiation signal output from the controller 3, to the balancing circuit unit 5 in parallel. Meanwhile, in the case the control signal output from the controller 3 is a balancing termination signal, the switch unit 4 restores the connection of the batteries B to a state before the parallel connection has been made and allows both terminals of the battery unit 1 to be connected to the external circuit unit 6 so that the balancing work is interrupted. For example, if an electric connection state among the batteries B is a series connection before the balancing mode is initiated, the switch unit 4 restores the connection state of the batteries B from the parallel connection to the series connection.

The balancing circuit unit 5 includes a resistor R. In the case the controller 3 outputs a balancing initiation signal, the resistor R is connected to both terminals of the plurality of batteries B connected in parallel, thereby configuring a discharge circuit for the battery unit 1.

As described above, since the balancing circuit unit 5 configures a discharge circuit for the plurality of batteries B connected in parallel, it is possible to balance the batteries B even though charge amounts of the batteries B are not individually adjusted. In other words, since voltages applied to both terminals of the plurality of batteries B connected in parallel are identical to each other, the batteries B may be rapidly balanced just by connecting the battery unit 1 and the balancing circuit unit 5.

Meanwhile, the balancing circuit unit 5 may further include at least one resistor r connected to adjacent batteries among the plurality of batteries B connected in parallel (see FIG. 2c). This ensures rapid and stable balancing since an excessive high current flowing between batteries B adjacent to each other is prevented.

Moreover, if the battery B is a battery pack or a battery rack, the balancing circuit unit 5 includes bus lines L connected to positive and negative terminals of a plurality of battery packs or a plurality of battery racks in parallel according to the balancing initiation signal of the controller 3. The bus lines L include a first bus line L1 contacting the positive terminal and a second bus line L2 contacting the negative terminal, and a resistor R is connected between the first bus line L1 and the second bus line L2 to serve as the balancing circuit unit 5 (see FIG. 3). Though not shown in the figures, likewise, resistors r may also be connected between every adjacent batteries B as shown in FIG. 2c to prevent the generation of excessive high current.

The external circuit unit 6 is connected between both terminals of the battery unit 1 to configure a closed circuit together with the battery unit 1 when the controller 3 outputs a balancing termination signal, and the external circuit unit 6 includes an external device D. The external device D has a concept including charger equipment and/or a device which operates with power supplied from the battery unit 1.

Meanwhile, even though it has been illustrated that the battery balancing system 10 balances the plurality of batteries B of the battery unit 1 at once, the present disclosure is not limited thereto. In other words, the battery balancing system 10 may also balance a group of batteries, which include just a part of the plurality of batteries B. In this case, the switch unit 4 may be installed in the battery balancing system 10 to connect a part of the plurality of batteries B to the balancing circuit unit 5 in parallel according to a control signal of the controller 3.

Moreover, the battery balancing system 10 may also be provided as a part of, to be included in, for example, electric equipment such as a power tool, charger equipment and a notebook computer; an electric vehicle; a hybrid vehicle; an energy storage system or the like.

However, applications of the battery balancing system 10 are not limited to the above examples, and the battery balancing system 10 according to the present disclosure may be applied to any device which operates with power supplied from a battery, and this is also within the scope of the present disclosure as obvious to those skilled in the art.

As described above, in the battery balancing system 10 according to a preferred embodiment of the present disclosure, the plurality of batteries B are simultaneously connected to the balancing circuit unit 5 in parallel in the balancing mode. By doing so, the battery balancing system 10 according to a preferred embodiment of the present disclosure gives an effect of rapid balancing with a simple circuit configuration.

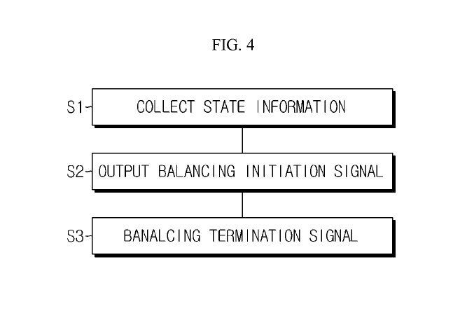

Next, a battery balancing method according to a preferred embodiment of the present disclosure will be described with reference to FIG. 4.

FIG. 4 is a flowchart for illustrating a battery balancing method according to a preferred embodiment of the present disclosure.

Referring to FIG. 4, the battery balancing method according to a preferred embodiment of the present disclosure includes (S1) collecting state information, (S2) outputting a balancing initiation signal, and (S3) outputting a balancing termination signal.

In Step S1, electric state information of the battery unit 1, measured by the state measuring unit 2 including a voltage measurer and/or a current measurer (not shown) and/or a temperature measurer (not shown), is collected. Here, the electric state information has a concept including not only electric state information of each battery B included in the battery unit 1 but also electric state information of the entire battery unit 1.

In Step S2, it is determined whether a balancing initiation condition is satisfied with reference to the collected state information, and if the condition is satisfied, a balancing initiation signal causing parallel connection between the plurality of batteries B and the balancing circuit unit 5 is output to the switch unit 4.

If the balancing initiation signal is output in Step S2, the switch unit 4 simultaneously connects the plurality of batteries B, which are to be balanced, to the balancing circuit unit 5 in parallel. In this case, since potentials applied to positive and negative terminals of the batteries B are identical, charge amounts of the batteries B are balanced more rapidly. In some embodiments, bus lines for commonly connecting positive and negative terminals of the batteries B, which are to be balanced, in parallel may be used.

In Step S3, after the balancing initiation signal is output, it is determined whether the balancing termination condition is satisfied with reference to the state information collected from the state measuring unit 2, and if the condition is satisfied, a balancing termination signal for causing the parallel connection between the plurality of batteries B and the balancing circuit unit 5 to be released is output to the switch unit 4.

If the balancing termination signal is output in Step S3, the switch unit 4 simultaneously releases the parallel connection between the batteries B, which are being balanced, and the balancing circuit unit 5 so that the electric connection state of the batteries B is restored to a state before the charge amount balancing process has been initiated. In addition, if necessary, the switch unit 4 electrically connects the battery unit 1 and the external circuit unit 6 to discharge the power stored in the battery unit 1 to the outside or charge the battery unit 1 with power received from the outside 1.

In Steps S2 and S3, the criteria for determining conditions of outputting a balancing initiation signal and a balancing termination signal have been described in detail above and are not described again.

The battery balancing method according to a preferred embodiment of the present disclosure may rapidly balance charge amounts of batteries by using a simple circuit configuration which simultaneously connects batteries, which should be balanced, to the balancing circuit unit in parallel.

In the present disclosure, components of the battery balancing system 10 according to a preferred embodiment of the present disclosure as shown in FIGS. 1 to 4 should be understood as logically distinguishable components, rather than physically distinguishable components.

In other words, in the present disclosure, each component corresponds to a logic component for implementing the technical spirit of the present disclosure. Therefore, even though components are integrated or divided, such integrated or divided components should be regarded as being within the scope of the present disclosure if the function of the logic configuration of the present disclosure is implemented. In addition, if a component performs a similar or identical function, the component should be regarded as being within the scope of the present disclosure regardless of its term.

The present disclosure has been described in detail. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

What is claimed is:

1. A battery balancing system for equalizing charge amounts of a plurality of batteries, the battery balancing system comprising:
a state measuring unit for measuring states of the plurality of batteries;
a controller for outputting a switching control signal including a balancing initiation signal and a balancing termination signal with reference to the state information measured by the state measuring unit; and
a switch unit for simultaneously connecting the plurality of batteries to a balancing circuit unit in parallel according to the balancing initiation signal and simultaneously releasing the parallel connection according to the balancing termination signal.

2. The battery balancing system according to claim 1, wherein the state measuring unit includes at least one of a voltage measurer, a current measurer and a temperature measurer.

3. The battery balancing system according to claim 2, wherein the controller calculates states of charge (SOCs) of the batteries by using the state information, compares a deviation of the SOCs with a reference value, and when a balancing initiation condition is satisfied, outputs the balancing initiation signal.

4. The battery balancing system according to claim 2, wherein the controller calculates a difference between a maximum value and a minimum value of the measured voltages of the plurality of batteries, compares the difference with a reference value, and when a balancing initiation condition is satisfied, outputs the balancing initiation signal.

5. The battery balancing system according to claim 4, wherein the controller outputs the balancing termination signal after passage of time which is proportional to a difference between a maximum value and a minimum value of voltages measured at both terminals of the plurality of batteries at the point when the balancing initiation signal is output.

6. The battery balancing system according to claim 4, wherein the controller compares current values between the batteries and the balancing circuit unit in the state information with a reference value and, when a balancing termination condition is satisfied, outputs the balancing termination signal.

7. The battery balancing system according to claim 4, wherein the controller compares a deviation of the SOCs or voltages of the batteries respectively calculated or measured during a balancing mode with a reference value and, when a balancing termination condition is satisfied, outputs the balancing termination signal.

8. The battery balancing system according to claim 1, wherein the balancing circuit unit includes a resistor connected between both terminals of each battery when the controller outputs the balancing initiation signal.

9. The battery balancing system according to claim 1, wherein the balancing circuit unit includes a resistor connected between adjacent batteries among the plurality of batteries when the controller outputs the balancing initiation signal.

10. The battery balancing system according to claim 1, wherein the switch unit connects the plurality of batteries to an external circuit unit when the parallel connection is released.

11. The battery balancing system according to claim 10, wherein the external circuit unit includes an external device connected at both terminals of each battery.

12. The battery balancing system according to claim 11, wherein the external device includes at least one of charger equipment and a device operating with power supplied from the batteries.

13. The battery balancing system according to claim 1, wherein the battery is any one selected from the group consisting of a unit cell, a battery module, a battery pack where a plurality of battery modules are connected, and a battery rack where the battery modules are loaded in multi layers.

14. The battery balancing system according to claim 13,
wherein the battery is the battery pack or the battery rack, and
wherein the balancing circuit unit has bus lines respectively connected to the battery modules.

15. The battery balancing system according to claim 14,
wherein the battery rack includes a plurality of the battery modules loaded therein, and
wherein the plurality of batteries are connected in parallel by the bus lines.

16. An electronic device to which the battery balancing system defined in claim 1 is applied.

17. An electric vehicle to which the battery balancing system defined in claim 1 is applied.

18. A hybrid vehicle to which the battery balancing system defined in claim 1 is applied.

19. A power storage device to which the battery balancing system defined in claim 1 is applied.

20. A battery balancing method for balancing charge amounts of a plurality of batteries by using a switch unit which connects the batteries to a balancing circuit unit in parallel or releasing the parallel connection, the battery balancing method comprising:
collecting state information of the plurality of batteries;
outputting a balancing initiation signal, which causes the parallel connection, to the switch unit when a balancing initiation condition is satisfied with reference to the collected state information; and
outputting a balancing termination signal, which causes the parallel connection to be released, to the switch unit when a balancing termination condition is satisfied with reference to the collected state information.
